(19) United States
(12) Patent Application Publication
(10) Pub. No.: US 2007/0155470 A1
(43) Pub. Date: Jul. 5, 2007

(54) Keno game with bonus

(76) Inventors: Kenneth Brunelle, Las vegas, NV (US); Danny R. Piper, (US)

Correspondence Address: Susan E. Money, 2300 E. Silverado Ranch Blvd. #1015, Las Vegas, NV, 89183, US

(21) Appl. No.: 11/709,455

(22) Filed: Feb. 21, 2007

(51) Int. Cl. G06F 19/00

(52) U.S. Cl. 463/18

(57) ABSTRACT

The present invention provides a game including a display defining a plurality of positions grouped into a plurality of zones. A bonus zone is chosen from among the zones, with a bonus symbol selected from among a set of playable symbols. Preferably, a player selects the bonus zone and the bonus symbol. A set of winning symbols are preferably randomly selected from the set of playable symbols and displayed on the display, with one winning symbol displayed in each of the plurality of positions. A bonus game is initiated if the bonus symbol matches any of the winning symbols displayed within the bonus zone.

### CROSS-REFERENCE TO RELATED APPLICATIONS

This application claims the benefit and priority of a U.S. Provisional Patent Application filed on Jan. 29, 2007, and entitled “Bonus Spin Video Keno Game,” which is incorporated herein by reference in its entirety.

### FIELD OF THE INVENTION

The present invention is directed to a game of chance, and more particularly to a keno game having a bonus feature.

### BACKGROUND OF THE INVENTION

In a standard game of keno, a player chooses between one and ten numbers from the numbers 1-80. Keno may be played electronically on a video keno machine wherein players select numbers using touch-screen technology, or live, with players selecting numbers by marking tickets. After a player selects numbers, twenty winning numbers are randomly selected from the field of eighty numbers. Weighted average paytables are used to award a payout based on the number of player numbers which matching the winning numbers. Typically, the paytables are based on the number of “spots” picked, or the number of player numbers selected. The more numbers that match, the higher the payout.

In a live keno game, typically the playable numbers (i.e., 1-80) are represented by eighty keno balls numbered 1 through 80. An air blower device circulates the balls within the device. The winning numbers are selected by randomly choosing twenty of the eighty balls. On a typical video keno machine, the winning numbers are displayed as “balls”, much like the winning numbers in the live keno game. The winning numbers enter a 2×10 grid as they are selected. In each game, there is a place on the screen or the game board where the winning numbers are displayed.

### SUMMARY OF THE INVENTION

The present invention provides a game including a display defining a plurality of positions. The positions are grouped into a plurality of zones, with a bonus zone chosen from among the zones, preferably by a player. At least one bonus symbol is selected from among a set of playable symbols. The bonus symbol is also preferably selected by the player. A set of winning symbols are preferably randomly selected from the set of playable symbols and displayed on the display, with one winning symbol displayed in each of the plurality of positions. A bonus game is initiated if the bonus symbol matches any of the winning symbols displayed within the bonus zone.

The present invention may further include a set of player symbols selected by the player from the set of playable symbols, with the player being awarded a payout if a predetermined number of the set of player symbols are present among the set of winning symbols. The bonus symbol is preferably selected from among the player symbols. In one aspect of the present invention, the bonus symbol is the first of the set of player symbols selected. In another aspect of the present invention, a plurality of bonus symbols are chosen, with the bonus game being initiated if a predetermined number of the bonus symbols match winning symbols displayed within the bonus zone. In still another aspect of the invention, a plurality of bonus zones are selected from among the zones, with the bonus game being initiated if the bonus symbol matches any of the winning symbols displayed within any of the plurality of bonus zones.

The present invention can be used with a video display or with a tangible, “live” display. The bonus zone and/or the bonus symbol may be accented on the display. The bonus game preferably includes a wheel rotatable about an axis and having a plurality of segments, with a bonus amount associated with each of the segments. When used with a traditional keno game, the set of playable symbols includes 80 symbols, the set of winning symbols includes 20 symbols, and the set of player symbols includes between 1 and 10 symbols. Preferably, as demonstrated, there are more symbols in the set of winning symbols than in the set of player symbols (e.g., 20 winning symbols vs. 1-10 player symbols).

The present invention also provides a method of playing a keno game. First, a set of playable numbers are defined. Next, a display defining a plurality of positions is provided, with the plurality of positions being grouped into a plurality of zones. Next, a bonus zone is selected from among the plurality of zones, and a bonus number is selected from among the set of playable numbers. A set of winning numbers is then chosen, preferably randomly, from the set of playable numbers. The winning numbers are displayed on the display with one winning number in each of the plurality of positions, such that at least one of the winning numbers is displayed within the bonus zone. The winning numbers displayed in the bonus positions are compared to the bonus number, with a bonus game being initiated if the bonus number matches any of the winning numbers displayed within the bonus zone. The method according to the present invention further contemplates selecting a set of player numbers from the set of playable numbers before selecting the winning numbers, comparing the set of player numbers to the set of winning numbers, and awarding a payout if a predetermined number of the set of player numbers are among the set of winning numbers. The bonus zone and/or the bonus number may be selected by a player. A plurality of bonus numbers may also be selected from among the set of playable numbers, with the bonus game being initiated if a predetermined number of the plurality of bonus numbers match winning symbols displayed within the bonus zone. The bonus number and/or the bonus zone may be accented on the display.

### BRIEF DESCRIPTION OF THE DRAWING

The above features and advantages and other features and advantages of the present invention are readily apparent from the following detailed description of the best modes for carrying out the invention when taken in connection with the accompanying drawings, wherein:

FIG. 1 is a schematic of a display according to the preferred embodiment of the present invention;

FIG. 2 is a schematic of a bonus game according to the present invention; and

FIG. 3 is a flowchart presenting a method of playing a game according the present invention.

### DESCRIPTION OF THE PREFERRED EMBODIMENTS

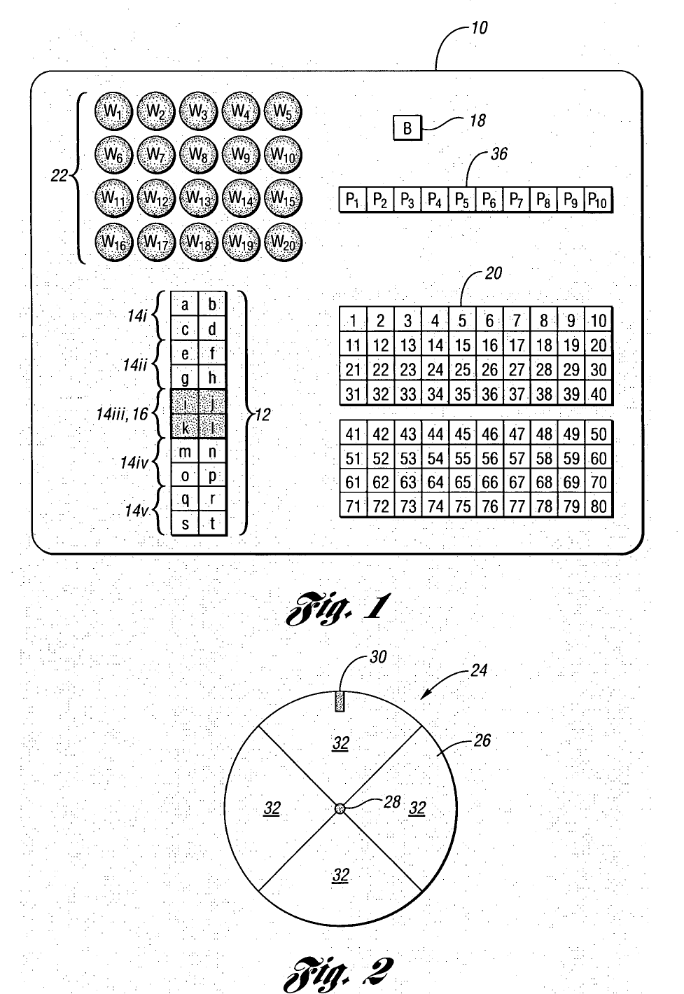

Referring to the drawings, wherein like numerals equal like parts, FIG. 1 is a schematic of a display 10 according to the preferred embodiment of the present invention. Particularly, the display 10 shows a video keno screen incorporating the present invention. The display 10 defines a plurality of winning positions 12, shown as a-t in a 2×10 grid in FIG. 1. The positions 12 are grouped into a plurality of zones 14. In the preferred embodiment shown, there are five zones, i-v. However, the present invention contemplates any number of zones 14. Preferably the total number of positions 12 is evenly divisible by the number of zones 14, such that there are an equal number of positions 12 within each zone 14. For example, in a traditional keno game wherein there are 20 winning positions 12, there could be 2, 4 or 5 zones 14, with 10, 5 or 4 numbers displayed within each zone 14, respectively. However, the zones 14 need not have an equal number of positions 12 to practice the present invention. In a keno game according to the present invention, at least one bonus zone 16 is selected from among the zones 14. The bonus zone 16 selected for the game represented by FIG. 1, particularly zone iii, is accented for clarity. The display 10 may accordingly accent the bonus zone 16. The bonus zone 16 is preferably selected by a player, but may be selected in another manner without changing the inventive concept. Additionally, a plurality of bonus zones 16 may be selected within the scope of the present invention.

At least one bonus number (B) 18 is selected from a set of playable numbers 20. In a traditional keno game, there are 80 playable numbers, 1-80. Preferably, the player selects the bonus number 18. Additionally, the present invention contemplates the selection of a plurality of bonus numbers 18. A set of winning numbers (W) 22 are preferably randomly selected from the set of playable numbers 20. Although the winning numbers 22 are not shown within the winning positions 12 for clarity, each winning position 12 displays one of the winning numbers 22. The winning numbers 22 may be placed within the positions 12 randomly or in a predetermined order. For instance, assume the winning numbers 22 are chosen in order from w₁ to w₂₀. It may be the case that w₁ is displayed in winning position s, w₂ is displayed in winning position q, . . . w₁₀ is displayed in winning position a, w₁₁ is displayed in winning position t, w₁₂ is displayed in winning position r, . . . and w₂₀ is displayed in winning position b. It may also be the case that the winning numbers 22 are randomly disbursed throughout the winning positions 12. The winning numbers 22 may be chosen simultaneously or in any manner of succession without changing the inventive concept.

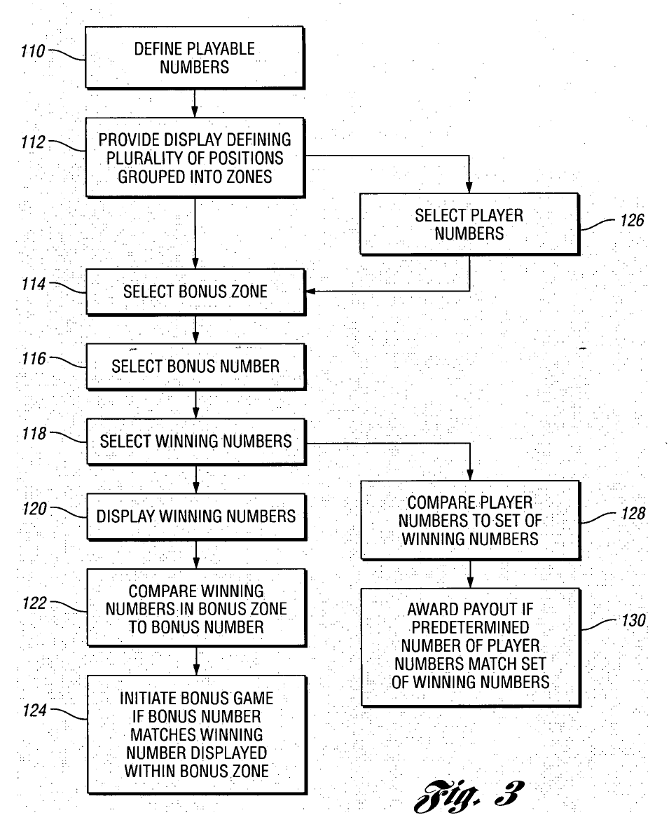

It can be seen that by placing the winning numbers 22 within the winning positions 12, at least some of the winning numbers 22 are displayed within the bonus zone 16. Winning numbers 22 displayed within the bonus zone 16 are compared to the bonus number 18. If the bonus number 18 matches one of the winning numbers 22 displayed within the bonus zone 16, a bonus game 24 (shown in FIG. 2) is initiated. In the preferred embodiment, the player selects two bonus numbers 18. When a plurality of bonus numbers 18 are selected, the bonus game 24 is initiated when a predetermined number of the bonus numbers 18 match winning numbers displayed within the bonus zone 16. Thus, if two bonus numbers 18 are selected, as in the preferred embodiment, the bonus game 24 is initiated if both of the bonus numbers 18 match winning numbers 22 displayed within the bonus zone 16. It may also be the case that a player selects two bonus numbers 18 and two bonus zones 16, with the bonus game 24 being initiated if both of the bonus numbers 18 match winning numbers 22 displayed within either of the bonus zones 16. To practice the present invention, it matters only that there is at least one bonus zone 16 and at least one bonus number 18, with a bonus game 24 being initiated if a predetermined number of bonus numbers 18 match winning numbers 22 displayed within the bonus zone(s) 16.

The preferred embodiment of the bonus game 24 is shown schematically in FIG. 2. The bonus game 24 includes a wheel 26 rotatable about an axis 28 and an indicator 30. The wheel 26 is divided into a plurality of segments 32. While only four segments 32 are shown for clarity, any number of segments 32 can be used. A bonus amount is associated with each segment 32. Upon initiation of the bonus game 24, the wheel 26 rotates about the axis 28, eventually slowing to a stop such that the indicator 30 indicates one of the segments 32. The player is then awarded the bonus amount associated with the segment 32 indicated by the indicator 30. It is preferable that the bonus game 24 be displayed prominently for viewing by others in the vicinity, with the excitement of the bonus game 24 perhaps encouraging others to play the game according to the present invention. It is also contemplated that a single wheel 26 is used when any of a plurality of game units according to the present invention. It may further be the case that the bonus game 24 is associated with a progressive jackpot, with the bonus amount associated with one of the segments 32 being the jackpot.

It is contemplated that the present invention will be utilized with a traditional keno game. As such, returning to FIG. 1, a set of player numbers 36, shown as p₁-p₁₀ in FIG. 1, are shown after having been selected from the set of playable numbers 20. In the preferred embodiment, the bonus numbers 18 are among the set of player numbers 36. For example, a player may select six player numbers 36, with the first two player numbers 36 selected being the bonus numbers 18. As with a traditional keno game, the set of player numbers 36 are compared with the set of winning numbers 22, with a payout being awarded if a predetermined number of the player numbers 36 is among the set of winning numbers 22. Thus, the bonus game 24 is somewhat secondary in the preferred embodiment of the present invention. While the present invention is shown using a video display 10, the invention may be practiced using a tangible display, i.e., as a “live” game, without changing the inventive concept. For example, in a “live” game, the winning positions could be actual physical positions on a game surface. Additionally, the winning numbers 22 are in effect potential winning numbers, with a payout awarded when a predetermined number of player numbers 36 match winning numbers 22, and a bonus game 24 initiated if a predetermined number of bonus numbers 18 match winning numbers 22 displayed within bonus zones 16.

Since FIG. 1 shows a typical video keno screen, the set of playable numbers 20 are 1 through 80 as indicated. Additionally, there are 20 winning positions 12, as discussed previously. The present invention can be used with an infinite combination of playable numbers and winning positions without changing the inventive concept. For instance, the playable numbers could be 110 through 167, with 10 winning positions instead of 20. Additionally, while keno games traditionally utilize numbers, the inventive concept contemplates the use of symbols other than numbers. For example, the playable numbers 20 could actually be different symbols, related or unrelated, such as a set of different fruits, or a set of different movie actors. To practice the present invention, it matters only that at least one bonus zone 16 and at least one bonus symbol 18 be selected before the winning symbols 22 are selected and placed within the winning positions 12.

Turning now to FIG. 3, a flowchart schematically depicts a method of playing a game according to the present invention. First, a set of playable numbers is defined in box 110. Next, a display is provided defining a plurality of positions in box 112, with the plurality of positions grouped into a plurality of zones. A bonus zone is selected from among the plurality of zones in box 114, while a bonus number is selected from among the set of playable numbers in box 116. Preferably, boxes 114 and 116 are completed by a player, but the player numbers and the bonus position(s) may be otherwise selected within the scope of the present invention. Additionally, a plurality of bonus zones may be selected from among the plurality of zones in box 114, while a plurality of bonus numbers may be selected from among the playable numbers in box 116. In box 118, a set of winning numbers are selected from the set of playable numbers. In box 120, the set of winning numbers are displayed on the display with one winning number displayed in each of the plurality of positions defined by the display. Winning numbers displayed within the bonus zone are compared to the bonus numbers in box 122, with box 124 initiating a bonus game if the bonus number matches any of the winning numbers displayed within the bonus zone. The winning numbers displayed within bonus positions and/or the bonus positions themselves may be highlighted on the display, i.e., a video screen or a live game board, for example. The method may further include selecting a set of player numbers from the set of playable numbers before selecting the set of winning numbers, as shown in box 126. Following selection of the winning numbers in box 118, the set of player numbers may be compared to the set of winning numbers, as shown in box 128. A payout is awarded in box 130 if a predetermined number of the set of player numbers are among the set of winning numbers.

While the best modes for carrying out the invention have been described in detail, it is to be understood that the terminology used is intended to be in the nature of words and description rather than of limitation. Those familiar with the art to which this invention relates will recognize that many modifications of the present invention are possible in light of the above teachings. As one example, the inventive concept could easily be networked between two or more machines, with the jackpot increasing across the network until it is awarded. It is, therefore, to be understood that within the scope of the appended claims, the invention may be practiced in a substantially equivalent way other than as specifically described herein.

1. A game comprising:
a display defining a plurality of positions, said plurality of positions being grouped into a plurality of zones;
a set of playable symbols;
a bonus zone selected from said plurality of zones, said bonus zone preferably selected by a player;
at least one bonus symbol selected from among said set of playable symbols, said at least one bonus symbol preferably selected by said player; and
a set of winning symbols preferably randomly selected from said set of playable symbols and displayed on said display such that one of said set of winning symbols is displayed in each of said plurality of positions;
wherein a bonus game is initiated if said at least one bonus symbol matches any of said winning symbols displayed within said bonus zone.

2. The game of claim 1, further comprising a set of player symbols selected by said player from said set of playable symbols, wherein said player receives a payout if a predetermined number of said set of player symbols are present among said set of winning symbols.

3. The game of claim 2, wherein said bonus symbol is selected from among said player symbols.

4. The game of claim 2, wherein said bonus symbol is the first of said set of player symbols selected.

5. The game of claim 1, wherein said at least one bonus symbol is a plurality of bonus symbols, said bonus game being initiated if a predetermined number of said bonus symbols match winning symbols displayed within said bonus zone.

6. The game of claim 1, wherein said display is one of a video display and a tangible display.

7. The game of claim 1, wherein one of said bonus zone and said at least one bonus symbol are accented on said display.

8. The game of claim 1, wherein said bonus game comprises a wheel rotatable about an axis, wherein said wheel has a plurality of segments with each of said segments having a bonus amount associated therewith.

9. The game of claim 1, further including a plurality of bonus zones, said bonus game being initiated if said at least one bonus symbol matches any of said winning symbols displayed within any of said plurality of bonus zones.

10. A method of playing a keno game comprising:
a) defining a set of playable numbers;
b) providing a display defining a plurality of positions, said plurality of position being grouped into a plurality of zones;
c) selecting a bonus zone from among said plurality of zones;
d) selecting a bonus number from among said set of playable numbers;
e) selecting a set of winning numbers from said set of playable numbers;
f) displaying said set of winning numbers on said display, wherein one of said set of winning numbers is displayed in each of said plurality of positions;
g) comparing said bonus number to said winning numbers displayed within said bonus zone; and
h) initiating a bonus game if said bonus number matches any of said winning numbers displayed within said bonus zone.

11. The method of claim 10, further including:
a) selecting a set of player numbers from said set of playable numbers before selecting said set of winning numbers;
b) comparing said set of player numbers to said set of winning numbers; and
c) awarding a payout if a predetermined number of said set of player numbers are among said set of winning numbers.

12. The method of claim 10, wherein a player selects said bonus zone.

13. The method of claim 10, wherein a player selects said bonus number.

14. The method of claim 10, wherein a plurality of bonus numbers are selected from among said set of playable numbers, and wherein said bonus game is initiated if a predetermined number of said plurality of bonus numbers match winning symbols displayed within said bonus zone.

15. The method of claim 10, wherein at least one of said bonus number and said bonus zone are accented on said display.

16. A game comprising:
a display defining a plurality of positions, said plurality of positions being grouped into a plurality of zones;
a bonus zone selected from said plurality of zones, said bonus zone preferably selected by a player;
a set of playable numbers;
a set of player numbers selected from said set of playable numbers, said set of player numbers preferably selected by a player;
at least one bonus number selected from among said set of player numbers, said at least one bonus number preferably selected by said player; and
a set of winning numbers preferably randomly selected from said set of playable numbers and displayed on said display such that one of said set of winning numbers is displayed in each of said plurality of positions;
wherein said player receives a payout if a predetermined number of said set of player numbers are present among said set of winning numbers; and
wherein a bonus game is initiated if said at least one bonus number matches any of said winning numbers displayed within said bonus zone.

17. The game of claim 16, wherein said bonus game comprises a wheel rotatable about an axis, said wheel having a plurality of segments, wherein each of said segments has a bonus value associated therewith.

18. The game of claim 16, wherein said at least one bonus number is a plurality of bonus numbers, said bonus game being initiated if a predetermined number of said bonus numbers match winning numbers displayed within said bonus zone.

19. The game of claim 16, further including a plurality of bonus zones, said bonus game being initiated if said at least one bonus number matches any of said winning numbers displayed within any of said plurality of bonus zones.

20. The game of claim 16, wherein said set of playable numbers includes 80 numbers, said set of winning numbers includes 20 symbols, said set of player symbols includes between one and ten numbers, said plurality of bonus zones includes one of two and five bonus zones.
